(19) United States
(12) Patent Application Publication
(10) Pub. No.: US 2021/0022370 A1
(43) Pub. Date: Jan. 28, 2021

(54) HIGH OLEIC FATTY ACID FEEDSTOCKS FOR RUMINANT FEED, METHODS OF PREPARATION AND USES

(71) Applicant: Perdue AgriBusiness LLC, Salisbury, MD (US)

(72) Inventors: Normand St-Pierre, Salisbury, MD (US); John Sylvester, Salisbury, MD (US); Jonas De Souza, Salisbury, MD (US)

(21) Appl. No.: 16/938,652

(22) Filed: Jul. 24, 2020

Related U.S. Application Data
(60) Provisional application No. 62/878,545, filed on Jul. 25, 2019.

(51) Int. Cl. A23K 20/158; A23K 20/24; A23K 50/10

(52) U.S. Cl. CPC A23K 20/158; A23K 50/10; A23K 20/24

(57) ABSTRACT

Compositions comprising feedstocks with high oleic acid content for ruminant feed, calcium soaps of the feedstocks, and methods of preparing ruminant feed and its use to increase fatty acid digestibility, increase milk production, increase milk fat, or increase body fat deposition in cows are presented. The high oleic acid feedstocks include from about 50 wt % to about 70 wt % oleic acid; no more than about 25 wt % polyunsaturated fatty acids; and unsaturated fatty acids, wherein less than about 20% of the fatty acids are present as a glyceride.

### CROSS-REFERENCE TO RELATED APPLICATION

This application claims priority to provisional application 62/878,545 filed Jun. 25, 2019, which is incorporated herein by reference in its entirety.

### TECHNICAL FIELD

The present invention relates to compositions and methods of making compositions having high oleic acid from soybean oil for ruminant feed. In particular, the compositions are feedstocks with high oleic acid content for ruminant feed. Calcium soaps of the feedstocks, methods of preparing ruminant feed and use to increase fatty acid digestibility, increase milk production, increase milk fat, or increase body fat deposition in cows are also described.

### BACKGROUND

Various ruminant feeds are available to improve the quality and quantity of milk. Yet, there remains a need for an improved ruminant feed and feedstocks for preparing them. It has been found that oleic acid is a particularly important fatty acid (i.e. FA) component in a ruminant feed. Oleic acid is bio-hydrogenated by microbes in the reticulorumen and, as a result, very little makes it to the ruminant small intestine. Additionally, oleic acid is needed to form micelles in the small intestine which is essential for all FA digestion (i.e. both saturated and unsaturated FAs).

Typical feedstocks containing FAs are derived from oils that contain significant amounts of polyunsaturated FAs, i.e. fatty acids with more than one double bond or degree of unsaturation, such as linoleic acid and linolenic acid. The presence of polyunsaturated FAs is disadvantageous because of their toxicity to ruminal bacteria and fiber digesting bacteria. Oleic acid is a particularly beneficial component of ruminant feeds because it allows for, among other things, increased milk quality and quantity. No viable processes exist that effectively increase the oleic acid content in source oils to a high enough level. While oils can be hydrolyzed and their FAs fractionated, this process is costly and it is difficult to separate different unsaturated FAs to achieve a high oleic acid content. Alternatively, the acids can remain combined, but this results in unacceptably high amounts of polyunsaturated FAs in order to provide a ruminant feed with sufficient amounts of oleic acid.

There thus remains a need for feedstocks for ruminant feed that are high in oleic acid content.

### BRIEF SUMMARY OF THE INVENTION

According to an embodiment, compositions comprising oleic FA calcium salts from a hydrolyzed high oleic soybean oil are described.

According to another embodiment, a method for increasing fatty acid digestibility and increasing milk and butterfat production in a ruminant is described, comprising feeding the ruminant a composition comprising oleic FA calcium salts derived from a hydrolyzed soybean oil that contains high levels of oleic acid.

Additional features, advantages, and embodiments of the invention are set forth or apparent from consideration of the following detailed description. Moreover, it is to be understood that both the foregoing summary of the invention and the following detailed description are exemplary and intended to provide further explanation without limiting the scope of the invention as claimed.

According to embodiments, the invention is a high oleic acid feedstock for a ruminant feed containing from about 50 wt % to about 70 wt % oleic acid; no more than about 25 wt % polyunsaturated fatty acids and other unsaturated fatty acids, wherein less than about 20% of the fatty acids are present as a glyceride.

In an embodiment, the high oleic acid feedstock is a calcium soap.

In an embodiment, methods of preparing a ruminant feed are described, that include the steps of combining a high oleic acid feedstock with a fat prill of at least 80% palmitic acid, a fat prill of at least 80% stearic acid, or a combination thereof, and forming a calcium soap from the combined feedstock and fat prill.

In an embodiment, methods for preparing a high oleic acid feedstock for ruminant feed are described, by hydrolyzing an oil source containing >65 wt % oleic acid to obtain a fatty acid substrate having a glyceride content of less than about 20 wt %; and adding palmitic and/or stearic acid to said fatty acid substrate to obtain a fatty acid mixture having oleic acid as 50-70 wt % of total fatty acids.

In an embodiment the fatty acid substrate contains less than about 25 wt % polyunsaturated fatty acids.

In an embodiment, the oil source is a modified soybean oil.

In an embodiment, the modified soybean oil is a genetically modified soybean oil.

In any embodiment, the preparation method can further include reacting the fatty acid mixture with a calcium source to obtain a calcium soap comprising less than 5% free fatty acids.

In any embodiment, the calcium source is calcium hydroxide or calcium oxide.

In an embodiment, methods for preparing a ruminant feed are described, using the steps of combining a high oleic acid feedstock having from about 50 wt % to about 70 wt % oleic acid; no more than about 25 wt % polyunsaturated fatty acids; and unsaturated fatty acids, wherein less than about 20% of the fatty acids are present as a glyceride, with at least one fat prill to obtain the ruminant feed.

In an embodiment, the high oleic acid feedstock in the feedstock contains from about 50 wt % to about 70 wt % oleic acid; no more than about 25 wt % polyunsaturated fatty acid and other unsaturated fatty acids, wherein less than about 20% of the fatty acids are present as a glyceride. In an embodiment, the high oleic acid feedstock is a calcium soap.

In any embodiment, the least one fat prill can be a palmitic acid fat prill, a stearic acid fat prill, or a combination thereof.

In an embodiment, a ruminant feed is described comprising about from about 5 wt % to about 75 wt % of oleic acid, from about 1 wt % to about 90 wt % of palmitic acid, and from about 5 wt % to about 90 wt % of stearic acid.

In an embodiment, the oleic acid in the ruminant feed is a calcium soap of oleic acid.

In an embodiment, the majority of the palmitic acid and the stearic acid in the ruminant feed are present as free palmitic acid and free stearic acids.

In an embodiment, the oleic acid, the palmitic acid, and the stearic acid in the ruminant feed are present as calcium soaps.

In an embodiment, methods for increasing fatty acid digestibility, increasing milk production, increasing butterfat production in milk, or increasing body fat in a cow, comprising feeding the cow the ruminant feed are described.

### DETAILED DESCRIPTION OF THE INVENTION

In the description and examples that follow, unless otherwise indicated, all parts and percentages are by weight. As used herein, the term “about” refers to plus or minus 10% of the indicated value. As used herein, the singular forms “a,” “an,” and “the” include plural referents unless the context clearly dictates otherwise.

Unsaturated FA are toxic to rumen microbes. In order to protect themselves, certain microbes saturate the unsaturated FA via a process known as biohydrogenation. In a normal ruminant, the FA leaving the rumen towards the lower digestive tract (i.e. intestine) are mostly saturated FA (i.e., the saturated FA in the diet plus the saturated FA from the biohydrogenation of the unsaturated FA). However, feeding too much unsaturated FA is not good for the rumen microbes and lowers the digestibility of the fiber fraction of the diet, which typically amounts to 30% of the diet's dry matter (i.e. intake), and less nutrients are absorbed by the cow. Furthermore, the biohydrogenation of polyunsaturated FA can easily be overwhelmed. This results in activation of an alternative biohydrogenation pathway that produces an isomer of C18:1 (i.e., an eighteen carbon fatty acid with double bond or degree of unsaturation). The C18:1 isomers produced are not all oleic acid. When a certain non-oleic isomer is absorbed, even in very small amounts, it has a marked bioactivity in the metabolism of the mammary gland that results in severe butterfat depression in the milk. In some instances, the butterfat in the milk drops from about 4% to <2.5%. This has a significant economic fallout as butterfat is a very valuable component in milk, typically representing 40-50% of the payment made to the dairy producer. Overfeeding of oleic acid alone can also cause this issue as some microbes possess an enzyme that can isomerize oleic acid to the detrimental C18:1 isomer. This is why polyunsaturated FAs are more problematic than monounsaturated FA.

Oleic acid is an important component of ruminant feed. Ruminant feed high in oleic acid and properly protected from ruminal biohydrogenation results in greater fatty acid digestibility and milk fat secretion compared to feeding linoleic-rich oils. However, directly feeding free unsaturated FA to ruminant interferes with bacterial species that ferment and digest dietary fiber in the cow's reticulorumen. While oils (i.e., vegetable triglycerides) can be safely fed in small amounts to ruminants, FAs in oils are less available and oils do not result in the benefits observed from free FAs. In particular, unsaturated FAs, such as oleic acid, are quite toxic to ruminate microorganisms. Additionally, unsaturated FA toxicity increases with their degree of unsaturation, with oleic acid being less toxic than linoleic acid, which is less toxic than linolenic, etc. Accordingly, to achieve the beneficial effects of unsaturated FAs, such as oleic acid, feeding a protected fat rather than the free FA is essential. Protected fats can be in the form of calcium soaps. The soaps provide unsaturated FAs with partial protection from biohydrogenation, thereby allowing some of the unsaturated FAs to pass to the abomasum (4^{th} compartment of the rumen stomach). While in the abomasum they dissociate from the calcium and reach the small intestine as simple free FAs for absorption.

The consumption of calcium soaps of unsaturated FA by ruminants has been shown to increase both the quality and quantity of milk. Despite the protection some of the unsaturated FAs still undergo saturation by ruminal microbes. Conversion to soaps is not necessary for saturated FAs as they are not nutritionally deleterious, and their conversion to soaps adds unnecessary cost. However, digestion of saturated FAs can also prove problematic as long-chain saturated FAs do not emulsify well and are incapable of micelle formation required for digestion.

High oleic soybeans, such as Pioneer's PLENISH soybeans containing in excess of 75% oleic acid, have been used as a source of high oleic oils, but they have not been employed as a free FA source in ruminant feed, much less as calcium soaps. Cows are usually fed the whole PLENISH soybean which contains the high oleic oil, as well as protein meal and high fiber hulls. The oleic acid is then largely biohydrogenated in the rumen absent calcium soap protection. PLENISH's benefit lies in the fact it contains little linoleic acid, making the soybean less toxic to rumen microbials. Palm oil, such as calcium salts using palm FA distillate or hydrolyzed from refined bleached and degummed (RBD) palm oil, and soybean oil FAs have typically been used as a FA source to make calcium soaps for ruminant feed. However, the resultant FA profiles are too low in oleic acid and can be high in linoleic acid. Typical oils are not enriched in oleic acid at the levels in high oleic varieties of oil seeds. Furthermore, to obtain a high concentration of oleic acid from typical palm or soybean oil requires separation of the desired oleic acid from other saturated and polyunsaturated FAs. Even after separation there can be substantial residual saturated and polyunsaturated FAs. As such, products containing high levels of substantially pure oleic FA are expensive and not readily available. It is also believed that feeding high amounts of calcium salt to cows may cause a drop in dry matter intake by the animals, which is undesirable. What is needed is a ruminant feed with a FA profile high in protected oleic acid that can be produced from readily available and inexpensive oils.

In a typical method, FAs to be used in a ruminant feed are hydrolyzed from an oil source and reacted with a calcium source to produce a FA calcium salt mixture. There is no attempt to modify the FA distribution prior to soap formation, and palm oil is the most widely used given its low cost. However, it is also believed that feeding high amounts of calcium salt to cows may cause a drop in dry matter intake which is detrimental to the cow's nutrition. It would be better to only prepare the calcium salt of the fatty acids that require protection, i.e., unsaturated fatty acids such as oleic acid. However, as described above, there are no commonly available fatty acid substrates with high oleic acid content and low content of polyunsaturated FAs that can be used to prepare the salts. There are oils that are known to contain high amounts of oleic acid, but their costs make use in ruminant feed uneconomical. For example, olive oil typically contains more than 70% oleic acid, peanut oil typically 58.5%, and canola oil typically 59.5%. All other oils typically contain less than 50% oleic acid. However, such oils are valuable for other food purposes and are generally too costly for use in preparing fatty acid blends for ruminant feed. As a result, vegetable oils used to prepare fatty acid substrates for ruminant feeds are high in polyunsaturated FAs, requiring separation of polyunsaturated FAs from the oleic acid to prepare a high oleic acid feedstock, adding time and expense. What is needed is a ruminant feed feedstock produced from readily available oils such as soybean oil with a FA profile high in protected oleic acid.

The present inventors have found that a calcium salt ruminant feedstock high in oleic acid can be produced from RBD or crude high oleic soybean oil. The resultant FAs calcium soaps can be blended in different concentrations with saturated FAs to produce unique calcium salt products for ruminant feed to optimize both milk quality and quantity. As used herein a high oleic acid source is defined as an oleic acid source having an oleic acid content of at least 60%, preferably at least 65%, more preferably at least 70%, and most preferably at least 75%. The oleic acid source is preferably a soybean oil or RBD. In particular embodiments, the source is a soybean oil from genetically modified soybeans. The genetically modified soybeans may be derived thorough selective breeding or biotechnological or genetic modification. Pioneer's PLENISH having a FA profile containing about 75% oleic acid, is an exemplary genetically modified soybean.

Accordingly, in embodiments, free FAs are isolated by acid hydrolysis of RBD or crude high oleic soybean oil. The glycerol is then removed, generally by centrifugation, and the free FA mixture may then be reacted with calcium hydroxide, calcium oxide, or other calcium sources to produce a high oleic acid calcium salt (soap). The calcium salt makes the FAs relatively inert to biohydrogenation in the rumen. This allows them to pass through to the small intestine for micelle formation and absorption. In a further embodiment, the high oleic calcium salt is mixed with prills of palmitic acid and/or stearic acid to produce various mixtures of rumen inert FAs. In a further embodiment, the FAs may be blended in different concentrations to produce unique calcium salt products for ruminant feed. According to embodiments, various formulations of specific FA products for dairy cows may target specific biological effects, such as increased body weight, increased milk production, and increased milk fat.

According to embodiments, a ruminant feedstock can be prepared from a source oil, such as a genetically modified (GMO) soybean oil high (>65%) in oleic acid (monounsaturated, C18:1) rather than a conventional soybean oil, which predominantly comprises linoleic acid (polyunsaturated, C18:2). In some embodiments, the process comprises first hydrolyzing the genetically modified soybean oil to make a FA substrate comprising less than 20% FA in the form of glycerides (i.e. step 1). As used herein, “glycerides” includes the total amount of mono-, di-, and tri-glycerides. A melted mixture of predominantly palmitic and stearic acids may be added to the FA substrate to lower the oleic acid content of the resulting FA mixture to between 50 and 70% of total FAs (i.e. step 2). According to embodiments, the resultant FA mixture is reacted with a calcium source (such as calcium oxide) to provide a FA calcium salt (soap) wherein more than 95% of the FAs are bound to an atom of Ca and less than 5% are left as free FAs (i.e. step 3).

In addition to the feedstock containing predominately the calcium soap of oleic acid, other FA containing feedstocks can be used in preparing the ruminant feed. These feedstocks include fat prills such as fat prills of predominantly palmitic acid (saturated, C16:0) and fat prills of predominately stearic acid (saturated C18:0). According to embodiments, the oleic calcium salt described above may be mixed in various proportions with fat prills of predominantly palmitic acid (saturated, C16:0) and/or fat prills of predominately stearic acid (saturated C18:0) with the sum of palmitic plus stearic acid in the prills exceeding 80% of total FAs in the prills (i.e. step 4). In some embodiments, the proportions of Ca salt produced in steps 1-3 and amount of prills added in step 4 vary according to, but not limited to, the physiological state of the cows (i.e., stage of lactation), the desired metabolic outcome (increase butterfat yields, increased protein yields, improvement in body condition of the animals), the genetic potential of the cows, the fat content in other feeds in the cow diet, and limitations in the handling systems (i.e., type of truck used for transportation, storage type, etc.).

In another embodiment, the FA substrate obtained from step 2 is mixed in various proportions with fat prills of predominantly palmitic acid (saturated, C16:0) and/or fat prills of predominately stearic acid (saturated C18:0). The resulting FA mixture is then reacted with a calcium source to provide a FA calcium soap.

While Ca soap formation is not necessary for saturated FAs, an advantage of using Ca soap of oleic acid is that the total calcium content in the ruminant feed is reduced. Typically, Ca makes up about 15% of the calcium soap. However, by mixing the high oleic acid FA calcium soaps with prills of saturated FAs, the total amount Ca in the ruminant feed is reduced from about 15% to less than about 5%. Removing and/or eliminating excess Ca soaps allows for more concentrated FA feedstock and reductions in shipping and manufacturing costs. Importantly, in ruminant feeds made according to the process of the invention, the Ca remains associated primarily with the oleic acid. Dissociation of the calcium from the oleic acid and recombination with the added saturated FAs generally results in less than about 5% loss in the oleic acid calcium salt, with more than 95% of the added oleic acid remaining in the salt form.

In general, increasing the amount of palmitic acid in the feed results in greater butterfat yields. Increasing the amount of stearic acid results in increased fat deposition. Increasing the amount of protected oleic results in better fat digestion by increasing total FA supplies to the cow, including palmitic and stearic FA. Increased energy supply to the cow results in increased milk and milk component yields. For example, can include milk protein yield drops if the energy supply was insufficient for maximum protein synthesis in the mammary gland.

In accordance with the principles of the invention, the blends of FAs of the invention partition nutrients toward either milk production and increased milk fat, or can partition nutrients towards body fat deposition so that the cow does not lose as much body weight. Other benefits include improved reproduction. Furthermore, the blends of FAs according to the claimed invention will allow for delivery of higher amounts of oleic acid to the small intestine of the cow without risk of decreasing intake, reduced fiber digestibility, and butterfat depression, all of which would be detrimental to the cow.

According to embodiments, the ruminant feed can be prepared from feedstocks containing various blends of FAs. Exemplary formulations include 15% of a high oleic acid soaps and 85% of a high palmitic (>80% palmitic) prill. Another formulation allows for the manufacturing of a feed that contains >80% palmitic (C16:0), or >90% stearic (C18:0), or >70% oleic, or any combination thereof. For example, a mixture of equal parts of a high oleic calcium salt, palmitic prills and stearic prills would result in a feed with approximately 30% stearic, 30% palmitic, and 23% oleic acids. The proportion of the 3 components (stearic prills, palmitic prills, oleic calcium salts) is dependent on the fatty acid composition of the remaining feeds making up the diet, the physiological status (i.e. health and age) and genetic potential of the animals, and the desired outcome, such as increased body fat deposition, milk yield, or butterfat yield.

In an embodiment, a ruminant feed according to the invention contains, as weight %, 5-75% oleic acid, 5-65% oleic acid, 5-55% oleic acid, 5-45% oleic acid, 5-35% oleic acid, 5-25% oleic acid, or 5-15% oleic acid by weight.

In an embodiment, the FA blend comprises, as weight %, 1-50% stearic acid, 1-40% stearic acid, 1-30% stearic acid, 1-20% stearic acid, or 1-10% stearic acid.

In an embodiment, the FA blend comprises, as weight %, 5-90% palmitic acid, 5-80% palmitic acid, 5-70% palmitic acid, 5-60% palmitic acid, 5-50% palmitic acid, 5-40% palmitic acid, 5-30% palmitic acid, 5-20% palmitic acid, or 5-10% palmitic acid.

A particular advantage of the invention is that the amount of individual FAs, especially polyunsaturated FAs, in the ruminant feed is more easily and precisely controlled. The high oleic acid feedstock, whether as the free acid or as the calcium soap, is produced with a greatly reduced content of polyunsaturated FAs. The only added components are palmitic and stearic acids added to achieve a desired fatty acid profile, and which are present in the ruminant feed in any event. Because the content of palmitic and stearic acids in the oleic acid feedstock is known and low, the ratio of oleic acid:palmitic acid:stearic acid can be readily calculated and controlled, allowing for customized formulations for use with specific purposes.

According to embodiments, RBD palm oil or crude high oleic soybean oil is hydrolyzed to isolate the free FAs, with limited remaining glyceride, for example less than 20 wt %. Then the free FAs are blended in different concentrations to produce unique calcium salt products for the ruminant feed industry. According to an embodiment of the invention, this can then be combined with saturated FA prills to minimize the amount of free polyunsaturated fats present in the ruminant feed.

According to embodiments, the invention allows for the formulation of specific FA products to be fed to dairy cows that have biological effects, such as increased body weight, increased milk production, or increased milk fat, which is an improvement over the prior art calcium salts of palm FA distillate, or from FAs hydrolyzed from RBD palm oil. In particular, making a salt with a high concentration of high oleic FAs in accordance with the claimed invention is not easily done and is not currently available. Typical oils utilized in ruminant feed are not enriched in oleic acid at the levels sufficient for their desired biological effects.

In accordance with the principles of the invention, dairy cows fed the blends of FAs of the instant invention partition nutrients toward either increased milk production and increased milk fat, or partition nutrients towards body fat deposition so the cow does not lose much body weight. It is believed that feeding high amounts of calcium salts to cows may cause a drop in feed intake. The present invention allows for delivery of higher amounts of oleic acid to the cow without the risk of decreasing intake.

According to embodiments, the claimed invention utilizes new types of soybeans, which beans contain oil with a high level of oleic acid as opposed to the high linoleic acid levels found in conventional soybeans. In some embodiments, the hydrolysis of this oil results in a mixture high in free oleic acid. This blend of free FAs is reacted with calcium hydroxide to produce a calcium salt (soap) high in oleic acid. The salt makes the FAs relatively inert in the rumen—an important feature because unprotected oleic acid, being unsaturated, is quite toxic to ruminate microorganism plus most of it would be hydrogenated in the rumen, hence delivering little oleic acid to the small intestine where it is needed to form fat micelles. This high oleic calcium salt can then be mixed with prills of palmitic acid and/or stearic acids to produce various mixtures of rumen inert FAs, with FA profiles that are optimized according to the stage of lactation, body condition of the animals, and level of milk production, and the fatty acid composition of the ingredients making up the balance of the diet.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

Although the foregoing description is directed to the preferred embodiments of the invention, it is noted that other variations and modifications will be apparent to those skilled in the art and may be made without departing from the spirit or scope of the invention. Moreover, features described in connection with one embodiment of the invention may be used in conjunction with other embodiments, even if not explicitly stated above.

1. A high oleic acid feedstock for a ruminant feed comprising:
from about 50 wt % to about 70 wt % oleic acid;
no more than about 25 wt % polyunsaturated fatty acids;
and unsaturated fatty acids,
wherein less than about 20% of the fatty acids are present as a glyceride.

2. The high oleic acid feedstock of claim 1, wherein the feedstock is a calcium soap.

3. A method of preparing a ruminant feed comprising
combining the feedstock of claim 1 with
a fat prill of at least 80% palmitic acid, a fat prill of at least 80% stearic acid, or a combination thereof, and
forming a calcium soap from the combined feedstock and fat prill.

4. A method for preparing a high oleic acid feedstock for ruminant feed comprising:
hydrolyzing an oil source containing >65 wt % oleic acid to obtain a fatty acid substrate having a glyceride content of less than about 20 wt %; and
adding palmitic and/or stearic acid to said fatty acid substrate to obtain a fatty acid mixture comprising oleic acid as 50-70 wt % of total fatty acids.

5. The method of claim 4, wherein the fatty acid substrate contains less than about 25 wt % polyunsaturated fatty acids.

6. The method of claim 4, wherein said oil source is a modified soybean oil or a refined, bleached, and degummed (RBD) palm oil.

7. The method of claim 6, wherein the modified soybean oil is a genetically modified soybean oil.

8. The method of claim 4, further comprising:
reacting said fatty acid mixture with a calcium source to obtain a calcium soap comprising less than 5% free fatty acids.

9. The method of claim 8, wherein said calcium source is calcium hydroxide or calcium oxide.

10. A method for preparing a ruminant feed comprising:
combining a high oleic acid feedstock comprising:
from about 50 wt % to about 70 wt % oleic acid;
no more than about 25 wt % polyunsaturated fatty acids; and
and unsaturated fatty acids,
wherein less than about 20% of the fatty acids are present as a glyceride. with at least one fat prill to obtain the ruminant feed.

11. The method of claim 10, wherein the high oleic acid feedstock is the feedstock of claim 1.

12. The method of claim 10, wherein the high oleic acid feedstock is the feedstock of claim 2.

13. The method of claim 11, wherein said at least one fat prill is selected from the group consisting of a palmitic acid fat prill, a stearic acid fat prill, or a combination thereof

14. The method of claim 12, wherein said at least one fat prill is selected from the group consisting of a palmitic acid fat prill, a stearic acid fat prill, or a combination thereof

15. A ruminant feed comprising about from about 5 wt % to about 75 wt % of oleic acid, from about 1 wt % to about 90 wt % of palmitic acid and from about 5 wt % to about 50 wt % of stearic acid.

16. The ruminant feed of claim 15, wherein the oleic acid is a calcium soap of oleic acid.

17. The ruminant feed of claim 16, wherein the majority of the palmitic acid and the stearic acid are present as free palmitic acid and free stearic acids.

18. The ruminant feed of claim 15, wherein the oleic acid, the palmitic acid and the stearic acid are present as calcium soaps.

19. A method for increasing fatty acid digestibility, increasing milk production, increasing butterfat production in milk, or increasing body fat in a cow, comprising feeding the cow the ruminant feed of claim 17.
